(19) United States
(12) Patent Application Publication
(10) Pub. No.: US 2003/0112397 A1
(43) Pub. Date: Jun. 19, 2003

(54) Biased bending vertical alignment mode liquid crystal display

(75) Inventor: Seok-Lyul Lee, Taoyuan (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Hannstar Display Corporation, Taoyuan (TW)

(21) Appl. No.: 10/154,711

(22) Filed: May 24, 2002

Related U.S. Application Data
(63) Continuation-in-part of application No. 10/020,262, filed on Dec. 13, 2001.

(51) Int. Cl. G02F 1/1337

(52) U.S. Cl. 349/129

(57) ABSTRACT

A liquid crystal display includes a first substrate having a first electrode, a second substrate having a second electrode, a plurality of slits formed on said second electrode and including a plurality of first slits and a plurality of second slits to divide the second electrode into a plurality of fragmented electrode portions, wherein said plurality of first slits are alternate with said plurality of second slits, a plurality of third electrodes disposed under said plurality of first slits, and a liquid crystal layer having a plurality of liquid crystal molecules and interposed between the first substrate and the second substrate. Meanwhile, orientations of the respective liquid crystal molecules positioned out of a vicinity above the slit are respectively aligned at a first and a second angles with respect to surfaces of the first substrate and the second substrate while there are a first-level and a second-level electric fields respectively across the liquid crystal layer.

### FIELD OF THE INVENTION

This is a continuation-in-part application of U.S. patent application Ser. No. 10/020,262, filed on Dec. 13, 2001. The present invention is in relation to a liquid crystal display (LCD), and more particularly, the present invention is in relation to a biased bending vertical alignment mode liquid crystal display.

### BACKGROUND OF THE INVENTION

The liquid crystal display (or LCD) is made up of two substrates and a liquid crystal layer interposed therebetween. The light is transmitted under the control of the electric field intensity applied to the liquid crystal layer.

The twisted nematic (TN) liquid crystal display, which is currently the most popular LCD, has a transparent matrix substrate and a transparent counter substrate, a pair of transparent electrodes respectively formed on the inner surface of the transparent substrates and opposite to each other so as to drive the liquid crystal layer interposed therebetween, and a pair of polarizing plates which are respectively attached to the outer surfaces of the transparent substrates. In the off state of the LCD, that is, in the state that the electric field is not applied to the transparent electrodes, the orientations of the liquid crystal molecules are aligned perpendicular to the substrates.

Unfortunately, the contrast ratio of the conventional TN LCD in a normally black mode may not be so high because the incident light is not fully blocked in the off state. In order to obviate this problem and increasing the viewing angles of LCD, various LCD modes have been presented. An example of the new LCD mode is known as vertical alignment (VA) mode. As the name suggests, the liquid crystal molecules are normally aligned perpendicular to the inner surface of the substrates, swinging through 90° to lie parallel with substrates in the presence of electric field. This LCD mode produces a display with an ultra-wide viewing angle and high contrast ratio but with the added bonus of higher brightness and a response time of 25 milliseconds. In addition, this LCD mode also consumes less power.

Following the advent of VA mode LCD, a new technique was proposed to align the liquid crystal molecules at a sub-level which uses UV light instead of the usual rubbing. This technique involves the addition of pyramid-shaped protrusions with each of liquid crystal cell, the surface of which each makes up a separate domain, in which the liquid crystal molecules are aligned differently from those in other domains. It produces increased viewing angles, at the expense of a reduction in brightness, by ensuring that each of the multiple domains within a pixel cell channel light at an angle to the substrates, instead of at right angles to it. The result is an all-round increase in viewing angle with no variation in color tone as the viewing angle increases and, requiring no rubbing, a simplified manufacturing process with a reduction in the possibility of liquid crystal contamination. When combined with the VA mode, the resultant display is known as a multi-domain vertical alignment (MVA) mode LCD and produces a viewing angle of 160° in all directions with a high contrast ratio of around 300:1.

However, the pyramid-shaped protrusions which are applied to control the tilt direction of the liquid crystal molecules are the major reasons for the low yield and high cost of the LCD products. There is an inclination to develop an active matrix LCD which has an improved response time, an increased viewing angle, an enhanced yield and a lower cost.

### SUMMARY OF THE INVENTION

The foregoing objectives can be attained by providing a liquid crystal display including a first substrate having a first electrode, a second substrate having a second electrode, a plurality of slits formed on the second electrode and having a plurality of first slits and a plurality of second slits to divide the second electrode into a plurality of fragmented electrode portions, wherein the plurality of first slits are alternate with the plurality of second slits, a plurality of third electrodes disposed under the plurality of first slits, and a liquid crystal layer having a plurality of liquid crystal molecules and interposed between the first substrate and the second substrate, wherein orientations of the respective liquid crystal molecules positioned out of a vicinity above the slit are respectively aligned from a first angle to a second angle with respect to surfaces of the first substrate and the second substrate while there are a first-level and a second-level electric fields respectively across the liquid crystal layer.

Certainly, orientations of the liquid crystal molecules in a vicinity above the slit can be aligned parallel to surfaces of the first substrate and the second substrate.

Certainly, the first angle and the second angle can be ranged from 70 to 90 and from 0 to 45 respectively.

Certainly, the first-level electric field can be a zero electric field.

Preferably, the liquid crystal molecules have a negative dielectric anisotropy.

Preferably, the liquid crystal display further includes a spacer for producing a gap between the first substrate and the second substrate.

Preferably, the spacer includes one of a metal and an organic material.

Preferably, the liquid crystal display further includes two polarizing plates respectively attached to the first substrate and the second substrate.

Preferably, the liquid crystal display further includes a plurality of switching elements.

Certainly, each of the switching elements can be a TFT.

Certainly, the first electrode and the second electrode can be formed of a transparent conductive material.

Certainly, the transparent conductive material can be an indium-tin-oxide.

Certainly, the first-level electric field and the second-level electric field can be controlled by means of adjusting relative potential between the first electrode and the second electrode.

Certainly, the first electrode and the second electrode and can be connected to a common voltage and a various voltage respectively.

Certainly, the third voltage can be connected to one of an independent electrode and a gate line.

According to the present invention, the liquid crystal display includes a first substrate having a first electrode, a second substrate having a second electrode, a plurality of slits formed on the second electrode and having a plurality of first slits and a plurality of second slits to divide the second electrode into a plurality of fragmented electrode portions, wherein the plurality of first slits are alternate with the plurality of second slits, a plurality of third electrodes disposed under the plurality of first slits, and a liquid crystal layer having a plurality of liquid crystal molecules and interposed between the first substrate and the second substrate.

According to the present invention, the liquid crystal display includes a first substrate having a common electrode, a second substrate having a plurality of pixel electrodes separated from each other by a plurality of slits having a plurality of first slits and a plurality of second slits, wherein the plurality of first slits are alternate with the plurality of second slits, a plurality of third electrodes disposed under the plurality of first slits, and a liquid crystal layer comprising a plurality of liquid crystal molecules and interposed between the first substrate and the second substrate, with a plurality of pixel parts being defined therein in a matrix form, wherein orientations of the respective liquid crystal molecules positioned out of a vicinity above the slit are respectively aligned from a first angle to a second angle with respect to surfaces of the first substrate and the second substrate while there are a first-level and a second-level electric fields respectively across the liquid crystal layer.

Certainly, the orientations of the liquid crystal molecules in a vicinity above the slit can be aligned parallel to surfaces of the first substrate and the second substrate.

Certainly, the first angle and the second angle can be ranged from 70 to 90 and from 0 to 45 respectively.

Certainly, the first-level electric field can be a zero electric field.

Preferably, the liquid crystal molecules have a negative dielectric anisotropy.

Preferably, the liquid crystal display further includes a spacer for producing a gap between the first substrate and the second substrate.

Preferably, the spacer includes one of a metal and an organic material.

Preferably, the liquid crystal display further includes two polarizing plates respectively attached to the first substrate and the second substrate.

Certainly, the common electrode and the pixel electrodes can be formed of a transparent conductive material.

Certainly, the transparent conductive material can be an indium-tin-oxide.

Certainly, the first-level electric field and the second-level electric field can be controlled by means of adjusting relative potential between the common and the pixel electrodes.

Preferably, the liquid crystal display further includes a plurality of switching elements.

Preferably, the third electrode is connected to a gate line.

Preferably, the second substrate further includes a gate insulating layer formed on the gate electrodes.

Preferably, the second substrate further comprises a semiconductor layer formed on a portion of the gate insulating layer over the gate electrodes.

Certainly, the common electrode and the pixel electrodes can be connected to a common voltage and a variable voltage respectively.

According to the present invention, the liquid crystal display includes a first substrate having a common electrode, a second substrate having a plurality of pixel electrodes separated from each other by a plurality of slits having a plurality of first slits and a plurality of second slits, wherein the plurality of first slits are alternate with the plurality of second slits, a plurality of third electrodes disposed under the plurality of first slits, and a liquid crystal layer comprising a plurality of liquid crystal molecules and interposed between the first substrate and the second substrate, with a plurality of pixel parts being defined therein in a matrix form.

Now the foregoing and other features and advantages of the present invention will be more clearly understood through the following descriptions with reference to the enclosed drawings, wherein:

### BRIEF DESCRIPTION OF THE DRAWINGS

FIG. 1 shows the structure of electrodes and the alignment of the liquid crystal molecules of LCD in the dark state in accordance with the present invention;

FIG. 2 shows the structure of electrodes and the alignment of the liquid crystal molecules of LCD in the white state in accordance with the present invention;

FIG. 3 is a plan view showing the pixel region of LCD according to a preferred embodiment of the present invention;

FIG. 4 shows a cross-sectional view of LCD according to a preferred embodiment of the present invention;

FIG. 5 shows a software simulation result of LCD in dark state;

FIG. 6 shows a software simulation result of the LCD in white state; and

FIG. 7 is a plan view showing the pixel region of LCD according to another preferred embodiment of the present invention.

### DETAILED DESCRIPTION OF THE PREFERRED EMBODIMENT

An exemplary embodiment of the present invention will now be described in detail by way of the following discussions with reference to the accompanying drawings. It is to be emphasized that the following descriptions of embodiments and examples of the present invention are only illustrative, and it is not intended to be exhaustive or not to be limited to the precise form disclosed.

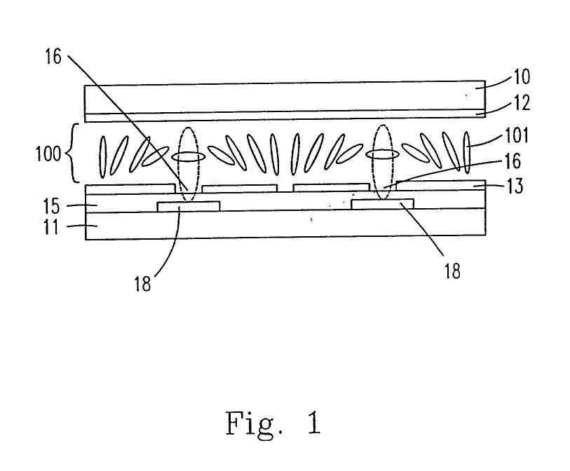

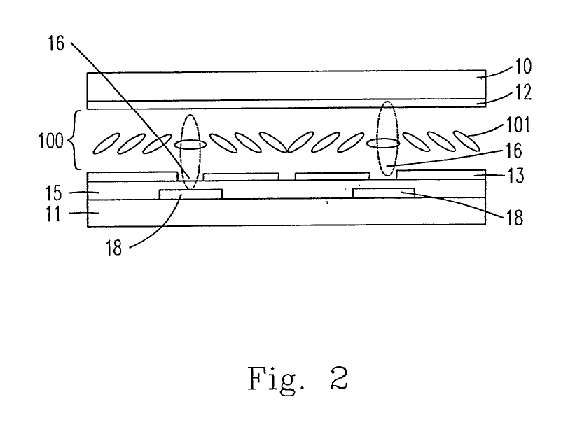

FIG. 1 shows the structure of electrodes and the alignment of the liquid crystal molecules of the LCD in the dark state in accordance with the present invention, and FIG. 2 shows the structure of electrodes and the alignment of the liquid crystal molecules of the LCD in the white state in accordance with the present invention. As indicated in FIG. 1 and FIG. 2, a matrix substrate 10 and a counter substrate 11 made of a transparent insulating material such as glass are spaced apart from each other. Two transparent electrodes 12 and 13 made of a transparent conductive material such as ITO (Indium-Tin-Oxide) are formed respectively on the inner surface of the glass substrates 10 and 11. A liquid crystal layer 100 including the liquid crystal molecules 101 having a negative dielectric anisotropy is disposed between the matrix substrate 10 and the counter substrate 11. On the outer surface of the substrates 10 and 11, an analyzer and a polarizer are respectively attached to the outer surface of the matrix substrate 10 and the outer surface of the counter substrate 11 (both of which are not shown in the drawings). The polarizer polarize the light beam incident on the liquid crystal layer 100 and the light beam out of the liquid crystal layer 100 respectively. The polarizing directions of the polarizer are perpendicular to each other. A light source (back light) is disposed on the rear of the LCD to act as an optical shutter (not shown). On the other hand, the matrix substrate 10 is further provided with a color filter (not shown).

Please refer to FIGS. 1-4. As shown in FIG. 1 and FIG. 2, the liquid crystal display embodying the present invention is constructed with a matrix substrate 10 and a counter substrate 11, and a liquid crystal layer 100 disposed between the matrix substrate 10 and the counter substrate 11. A common electrode 12 is provided to cover the entire surface of the matrix substrate 10 and a pixel electrode 13 is provided on the inner surface of the counter substrate 11. In accordance with a preferred embodiment of the present invention, the pixel region of LCD is constituted by a matrix consisting of a plurality of scanning electrodes 14 (gate electrodes) and a plurality of signal electrodes 17 (data electrodes) being arranged in a crossover form. Both the gate electrodes 14 and the signal electrodes 17 are part of a switching element such as a thin film transistor (or TFT), which is formed on the counter substrate 11 and connected to the pixel electrode 13. Parts of slits 16 are created on the pixel electrode 13 over the center of the third electrode 18 but relative parts of slits 16′ are created on the pixel electrode without covering the third electrode 18. When the slits 16 and the relative slits 16′ are created on the pixel electrodes 13, the pixel electrode 13 is divided into a plurality of fragmented electrode portions. The same signal voltage must be applied to fragmented electrode portions, and an electric connection must be established to interconnect these fragmented electrode portions.

FIG. 1 shows the dark state that the electric field is not applied to the liquid crystal layer 100. The pixel electrode 13 having slits 16 formed over the third electrodes 18 is provided over the matrix consisting of the gate electrodes 14 and the orthogonal signal electrodes 17. The liquid crystal molecules 101 in the liquid crystal layer 100 are aligned perpendicular to the inner surface of the first substrate 10 and the second substrate 11, but the liquid crystal molecules 101 in the vicinity of slit 16 in the liquid crystal layer 100 are aligned parallel to the inner surface of the first substrate 10 and the second substrate 11. The polarized light which is generated by the polarizer passes through the portion of the liquid crystal layer 100 where the liquid crystal molecules are aligned vertical with respect to the first substrate 10 and the second substrate 11, so as to make a dark state.

As discussed above, in the absence of electric field, i.e. there is no voltage difference between the first electrode 12 and the second electrode 13, the liquid crystal molecules 101 are aligned perpendicular to the inner surface of the substrates 10 and 11. However, the liquid crystal molecules in the vicinity of slit 16 on the pixel electrode 13 and over the third electrodes 18 are aligned parallel to the inner surface of the substrates 10 and 11. Because the voltage difference between the third electrodes 18 and the common electrode 12 is maintained high enough to keep the oblique liquid crystal molecules 101 parallel to the inner surface of the substrates 10 and 11, the electric field applied to the liquid crystal layer 100 can determine the direction in which the liquid crystal molecules 101 are tilted. The orientation of the liquid crystal molecules 101 is divided into different direction along a plane defined by each pair of fragmented electrode portions over the third electrode 18.

FIG. 2 shows the white state that the sufficient electric field is applied to the liquid crystal layer 100 by the first electrode 12 and the second electrode 13, in which the liquid crystal molecules 101 in the liquid crystal layer 100 are tilted from the counter substrate 11 to the matrix substrate 10, and the direction of the liquid crystal layer 100 varies continuously. The polarized light generated by the polarizer passes through the liquid crystal layer 100 and its polarization is rotated by 90° in accordance with the variation of direction of the liquid crystal layer 100. In this way, the light passes through the analyzer will make a white state. It can be seen from FIG. 2 that if a predetermined voltage difference is applied to the common electrode 12 and the fragmented electrode portions 13, the liquid crystal molecules 101 will easily and rapidly aligned parallel to the inner surface of the substrates 10 and 11, and a white display will appear.

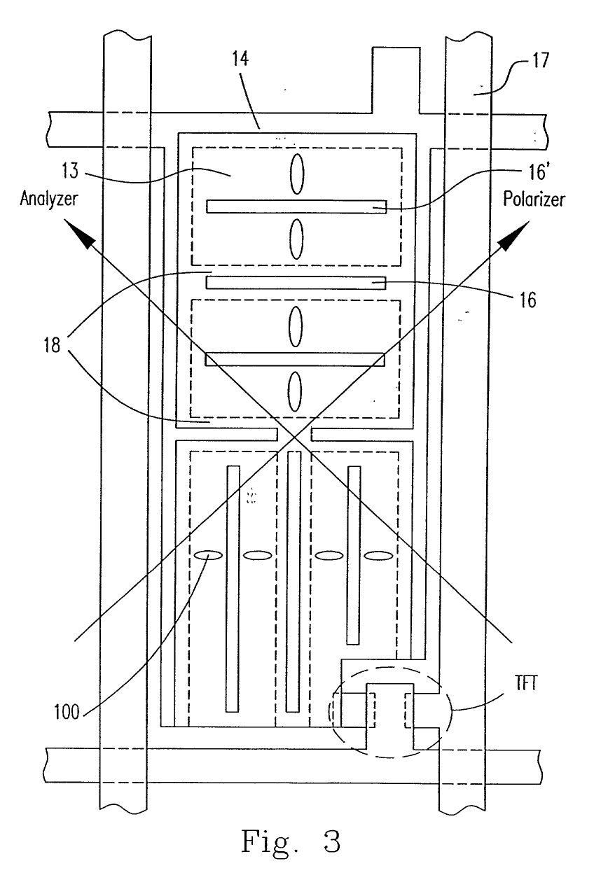

FIG. 3 shows the pixel region of LCD according to a preferred embodiment of the present invention. As shown in FIG. 3, the gate lines 14 are extended horizontally or transversely and crisscross arranged with the signal lines 17 to from a matrix of pixels. A thin film transistor (or TFT) as a switching element is provided at the intersection of the gate lines 14 and the signal line 17. The pixel electrodes 13 are provided in matrix and each connected to the TFT. A plurality of slits 16 are provided on the pixel electrodes 13 to divide the pixel electrodes 13 into a plurality of fragment electrode portions. The third electrodes 18 is connected to the gate electrode 14. A spacer (not shown) is provided between the matrix substrate and the counter substrate to produce a gap. A liquid crystal material having a negative dielectric anisotropy is injected into the gap through an injection port (not shown) between the substrates to form a liquid crystal layer 100. Subsequently the injection port is sealed, and a pair of polarizing plates are attached to their respective substrates to finish the production of a LCD.

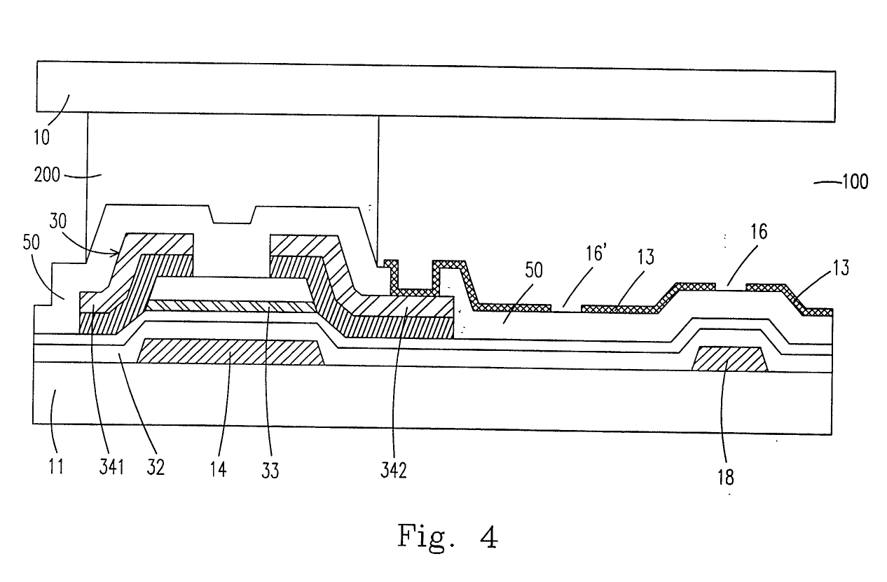

FIG. 4 shows a cross-sectional view of the LCD according to a preferred embodiment of the present invention. As shown in FIG. 4, a spacer 200 formed of a metal or an organic material is formed on the TFT 30 to produce a gap between the matrix substrate 10 and the counter substrate 11. A liquid crystal layer 100 is disposed between the counter substrate 11 having a TFT 30 and a matrix counter having a color filter (not shown). The TFT 30 formed on the counter substrate 11 includes a gate electrode 14, a gate insulating layer 32 formed thereon, an a-Si semiconductor layer 33 formed on a portion of the gate insulating layer 32 over the gate electrode 14, and source/drain electrodes 341 and 342 formed on the a-Si semiconductor layer 33. A passivation film 50 covers the enter surface of counter substrate 1. A pixel electrode 13 is formed in the pixel region and electrically coupled to the drain region 342 through a contact hole in the passivation film 50. Parts of the slits 16 are created on the pixel electrodes 13 over the third electrodes 18 but relative parts of the slits 16′ are created on the pixel electrodes 13 without covering the third electrodes 18, wherein the slits 16 and the relative slits 16′ divide the pixel electrodes 13 into a plurality of fragmented electrode portions.

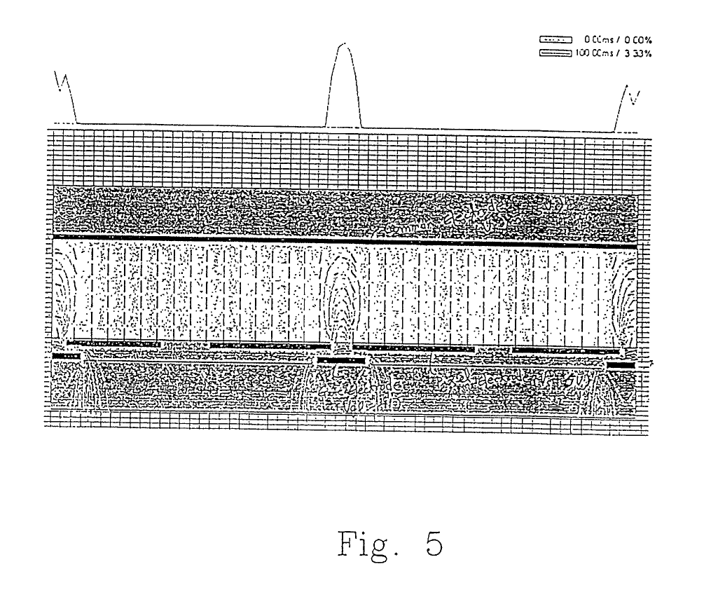

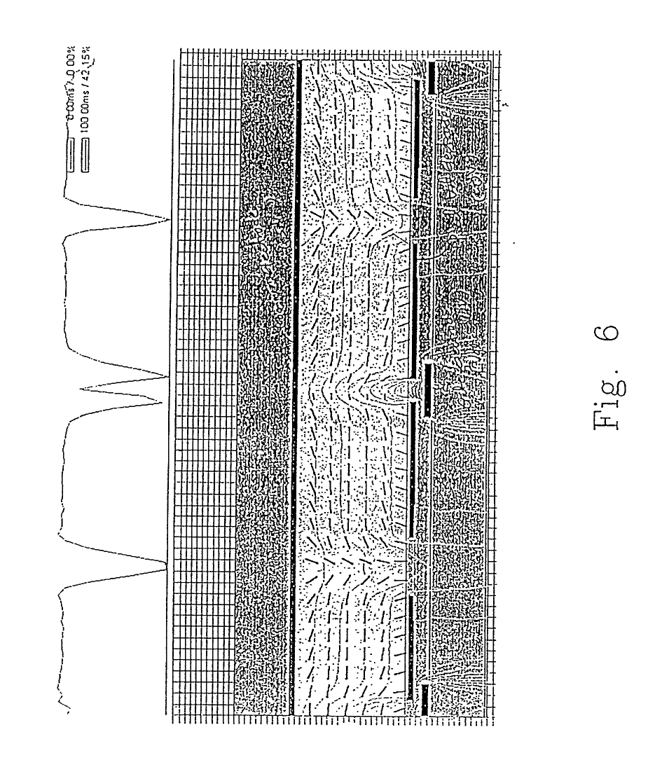

FIG. 5 and FIG. 6 respectively exhibits the software simulation results of the alignment of the liquid crystal molecules of LCD in the dark state and in white state. It can be clearly understood from FIG. 5 that the liquid crystal molecules are aligned perpendicular to the surfaces of substrates to make dark display, except for the liquid crystal molecules in the vicinity of the slits which are lay parallel to the surfaces of substrates. In FIG. 6, it is readily known that the liquid crystal molecules are lay parallel to the surfaces of the substrates to make white display. It should be noted that the software simulation results of alignment of the liquid crystal molecules in FIG. 5 and FIG. 6 respectively has the same profile as those shown in FIG. 1(a) and FIG. 1(b), which further proves the practicability of the function of LCD according to the present invention.

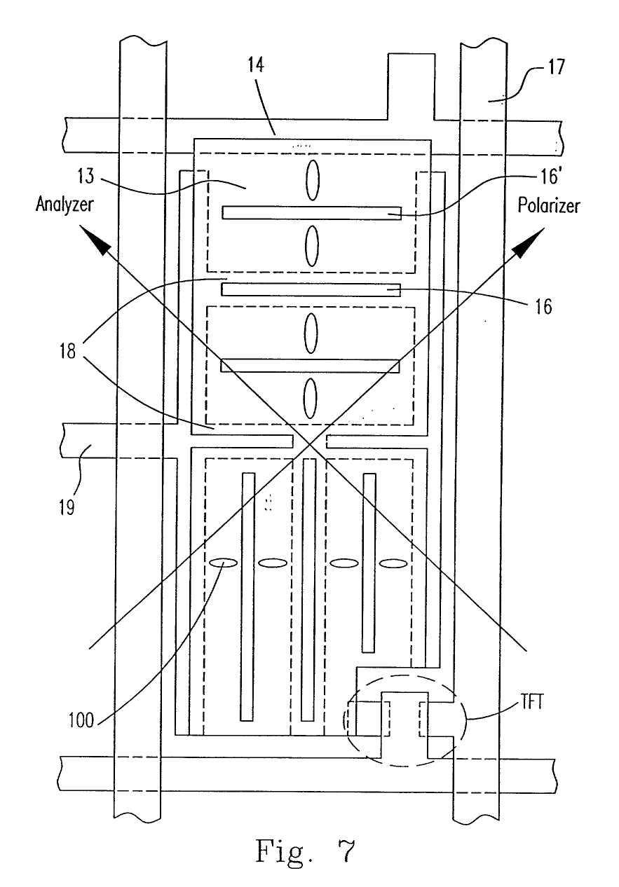

FIG. 7 shows the pixel region of LCD according to another preferred embodiment of the present invention. As shown in FIG. 7, the gate lines 14 are extended horizontally or transversely and crisscross arranged with the signal lines 17 to from a matrix of pixels. A thin film transistor (or TFT) as a switching element is provided at the intersection of the gate lines 14 and the signal lines 17. The pixel electrodes 13 are provided in matrix and each connected to the TFT. Parts of slits 16 over the third electrodes 18 are provided on the pixel electrodes 13 but relative parts of slits 16′ are provided on the pixel without covering the third electrodes 18, wherein the slits 16 and the relative slits 16′ divide the pixel electrodes 13 into a plurality of fragment electrode portions. In FIG. 3, the third electrode 18 is connected to the gate electrode 14, but the third electrodes 18 in FIG. 7 is connected to an independent electrode 19, which is not connected to the gate electrodes 14. The various case of bias voltage pairs according to FIG. 7 of the present invention could optimize LC tilt angle in surround slit ITO over the third electrode.

As described above, the orientations of the liquid crystal molecules of the LCD according to the present invention is determined by the electric field intensity across the liquid crystal layer. By way of dividing the pixel electrode on the counter substrate into a plurality of fragmented electrode portions so as to create parts of slits 16 over the third electrode and relative parts of slits 16′, the dark state and the white state of the LCD can be readily and easily achieved by controlling the orientations of the liquid crystal molecules through the electric field across the fragmented electrode portions and the common electrode. In comparison with the prior MVA technology, the present invention substantially removes the protrusions on the matrix substrate, and the liquid crystal alignment method of the liquid crystal display can be accomplished by appropriately applying electric field across the common electrode and fragmented pixel electrodes overlapping the third electrode to make the dark state and the white state. Owing to the removal of the protrusions, it is known that the present invention is advantageous in terms of response time, viewing angle, yield and manufacturing cost.

Those of skill in the art will recognize that these and other modifications can be made within the spirit and scope of the present invention as further defined in the appended claims.

What is claim is:

1. A liquid crystal display comprising:
a first substrate having a first electrode;
a second substrate having a second electrode;
a plurality of slits formed on said second electrode and including a plurality of first slits and a plurality of second slits to divide said second electrode into a plurality of fragmented electrode portions, wherein said plurality of first slits are alternate with said plurality of second slits;
a plurality of third electrodes disposed under said plurality of first slits; and
a liquid crystal layer having a plurality of liquid crystal molecules and interposed between said first substrate and said second substrate,
wherein orientations of said respective liquid crystal molecules positioned out of a vicinity above said slit are respectively aligned from a first angle to a second angle with respect to surfaces of said first substrate and said second substrate while there are a first-level and a second-level electric fields respectively across said liquid crystal layer.

2. The liquid crystal display of claim 1, wherein orientations of said liquid crystal molecules in a vicinity above said slit are aligned parallel to surfaces of said first substrate and said second substrate.

3. The liquid crystal display of claim 1, wherein said first angle and said second angle are ranged from 70 to 90 and from 0 to 45 respectively.

4. The liquid crystal display of claim 1, wherein said first-level electric field is a zero electric field.

5. The liquid crystal display of claim 1, wherein said liquid crystal molecules have a negative dielectric anisotropy.

6. The liquid crystal display of claim 1, further comprising a spacer for producing a gap between said first substrate and said second substrate.

7. The liquid crystal display of claim 6, wherein said spacer comprises one of a metal and an organic material.

8. The liquid crystal display of claim 1, further comprising two polarizing plates respectively attached to said first substrate and said second substrate.

9. The liquid crystal display of claim 1, further comprising a plurality of switching elements.

10. The liquid crystal display of claim 9, wherein each of said switching elements is a TFT.

11. The liquid crystal display of claim 1, wherein said third electrode is connected to a gate line.

12. The liquid crystal display of claim 1, wherein said first electrode and said second electrode are formed of a transparent conductive material.

13. The liquid crystal display of claim 12, wherein said transparent conductive material is an indium-tin-oxide.

14. The liquid crystal display of claim 1, wherein said first-level electric field and said second-level electric field are controlled by means of adjusting relative potential between said first electrode and said second electrode.

15. The liquid crystal display of claim 14, wherein said first electrode and said second electrode are connected to a common voltage and a various voltage respectively.

16. The liquid crystal display of claim 1, wherein said third electrode is connected to an independent electrode.

17. A liquid crystal display comprising:
a first substrate having a first electrode;
a second substrate having a second electrode;
a plurality of slits formed on said second electrode and including a plurality of first slits and a plurality of second slits to divide said second electrode into a plurality of fragmented electrode portions, wherein said plurality of first slits are alternate with said plurality of second slits;
a plurality of third electrodes disposed under said plurality of first slits; and
a liquid crystal layer having a plurality of liquid crystal molecules and interposed between said first substrate and said second substrate.

18. A liquid crystal display comprising:
a first substrate having a common electrode;
a second substrate having a plurality of pixel electrodes separated from each other by a plurality of slits including a plurality of first slits and a plurality of second slits, wherein said plurality of first slits are alternate with said plurality of second slits;
a plurality of third electrodes disposed under said plurality of first slits; and
a liquid crystal layer comprising a plurality of liquid crystal molecules and interposed between said first substrate and said second substrate, with a plurality of pixel parts being defined therein in a matrix form,
wherein orientations of said respective liquid crystal molecules positioned out of a vicinity above said slit are respectively aligned from a first angle to a second angle with respect to surfaces of said first substrate and said second substrate while there are a first-level and a second-level electric fields respectively across said liquid crystal layer.

19. The liquid crystal display of claim 18, wherein orientations of said liquid crystal molecules in a vicinity above said slit are aligned parallel to surfaces of said first substrate and said second substrate.

20. The liquid crystal display of claim 18, wherein said first angle and said second angle are ranged from 70 to 90 and from 0 to 45 respectively.

21. The liquid crystal display of claim 18, wherein said first-level electric field is a zero electric field.

22. The liquid crystal display of claim 18, wherein said liquid crystal molecules have a negative dielectric anisotropy.

23. The liquid crystal display of claim 18 further comprising a spacer for producing a gap between said first substrate and said second substrate.

24. The liquid crystal display of claim 23, wherein said spacer comprises one of a metal and an organic material.

25. The liquid crystal display of claim 18, further comprising two polarizing plates respectively attached to said first substrate and said second substrate.

26. The liquid crystal display of claim 18, wherein said common electrode and said pixel electrodes are formed of a transparent conductive material.

27. The liquid crystal display of claim 26, wherein said transparent conductive material is an indium-tin-oxide.

28. The liquid crystal display of claim 18, wherein said first-level electric field and said second-level electric field are controlled by means of adjusting relative potential between said common and said pixel electrodes.

29. The liquid crystal display of claim 18, further comprising a plurality of switching elements.

30. The liquid crystal display of claim 29, wherein each of said switching element further comprises a gate electrode.

31. The liquid crystal display of claim 30, wherein said third electrode is connected to said gate electrode.

32. The liquid crystal display of claim 30, wherein said second substrate further comprises a gate insulating layer formed on said gate electrodes.

33. The liquid crystal display of claim 30, wherein said second substrate further comprises a semiconductor layer formed on a portion of said gate insulating layer over said gate electrodes.

34. The liquid crystal display of claim 31, wherein said common electrode and said pixel electrodes are connected to a common voltage and a variable voltage respectively.

35. The liquid crystal display of claim 18, wherein said third electrode is connected to an independent electrode.

33. A liquid crystal display comprising:
a first substrate having a common electrode;
a second substrate having a plurality of pixel electrodes separated from each other by a plurality of slits including a plurality of first slits and a plurality of second slits, wherein said plurality of first slits are alternate with said plurality of second slits;
a plurality of third electrodes disposed under said plurality of first slits; and
a liquid crystal layer comprising a plurality of liquid crystal molecules and interposed between said first substrate and said second substrate, with a plurality of pixel parts being defined therein in a matrix form.
